(19) United States
(12) Patent Application Publication
(10) Pub. No.: US 2007/0258384 A1
(43) Pub. Date: Nov. 8, 2007

(54) METHOD AND SYSTEM FOR ENHANCED BASIC SERVICE SET TRANSITION FOR A HIGH THROUGHPUT WIRELESS LOCAL AREA NETWORK

(75) Inventors: Mohammed Sammour, Montreal (CA); Marian Rudolf, Montreal (CA); Sudheer A. Grandhi, Mamaroneck, NY (US); Joseph S. Levy, Merrick, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/680,892

(22) Filed: Mar. 1, 2007

Related U.S. Application Data
(60) Provisional application No. 60/778,767, filed on Mar. 3, 2006.

(51) Int. Cl. H04J 3/14

(52) U.S. Cl. 370/252

(57) ABSTRACT

A wireless local area network (WLAN) includes at least one high throughput-enabled access point (AP) and at least one high throughput-enabled station (STA). A STA and a target AP communicate high throughput-related information and the STA performs a basic service set (BSS) transition to the target AP based on the high throughput-related information. The high throughput-related information may be included in an IEEE 802.11r, 802.11k, or 802.11v signaling message. The STA may send measurement reports for an extended range and a normal range of an AP separately, or may send a combined measurement report for an extended range and a normal range of an AP. A network management entity may obtain current status information of the STA and the AP regarding high throughput capabilities, features and parameters and selectively enable and disable at least one of the high throughput capabilities, features and parameters of the STA and the AP.

### CROSS REFERENCE TO RELATED APPLICATION

This application claims the benefit of U.S. Provisional Application No. 60/778,767 filed Mar. 3, 2006, which is incorporated by reference as if fully set forth.

### FIELD OF INVENTION

The present invention is related to a wireless local area network (WLAN). More particularly, the present invention is related to a method and system for enhanced basic service set (BSS) transition for high-throughput WLAN systems.

### BACKGROUND

The IEEE 802.11r amendment to the IEEE 802.11 WLAN standards describes fast basic service set (BSS) transition. The goal of the IEEE 802.11r amendment is to minimize the amount of time that data connectivity between a station (STA) and a distribution system (DS) is lost during a BSS transition. According to the IEEE 802.11r amendment, a STA may establish security and a quality of service (QoS) state at a new AP with minimal connectivity loss to the DS.

IEEE 802.11r defines three stages for a BSS transition from a current AP to a new AP. In a discovery stage, a STA locates and determines to which AP it will attempt a transition. IEEE 802.11r BSS transition services provide a mechanism for the STA to communicate and retrieve information on target AP candidates prior to making a transition. In a resource establishment stage, the STA may determine that the target AP will provide connection resources that the STA needs to maintain active sessions. IEEE 802.11r fast BSS transition services provide a mechanism for the STA to reserve resources at a target AP, prior to making a transition or at the time of re-association with the target AP. In a transition stage, the STA abandons the current AP and establishes a connection with the new AP. IEEE 802.11r fast BSS transition services provide a mechanism for the STA to re-associate with the target AP while minimizing any latency introduced from protocol overhead.

The STA may communicate with the target AP directly using IEEE 802.11 authentication frames, (i.e., “over-the-air”), or via a currently associated AP, (i.e., “over-the-DS”). In an over-the-DS case, the communication between the STA and the target AP is carried in fast transition action frames between the STA and the current AP and using an encapsulation method between the current AP and the target AP.

IEEE 802.11n has been proposed to improve throughput in a WLAN. Unlike IEEE 802.11a/b/g standards, many optional features, capabilities and parameters in medium access control (MAC) and physical layers are defined in IEEE 802.11n. This gives rise to a potentially problematic situation where one AP, (e.g., a current AP), supports a certain set of capabilities, features and/or parameters, while another AP, (e.g., a target AP), supports a different set of capabilities, features and/or parameters which are not identical with the current AP's.

Situations like this may arise not only when equipment from different vendors is deployed in a network, but may also arise when different configurations are applied to APs to serve different traffic needs. This may cause problems related to performance, QoS, or the like, when the STA initiates a BSS transition because the STA does not know which capabilities, features and parameters are supported by the target AP for the ongoing session.

For example, when an IEEE 802.11n-enabled STA is served by an AP in a 40 MHz channel and if the target AP only supports a 20 MHz channel, there is a high potential that the STA may not experience the same throughput after a BSS transition. In the current state-of-the-art, a STA does not have knowledge of high-throughput-related capabilities, features and parameters implemented or currently used in a neighbor AP.

In another example, a high-throughput STA implementing specialized power-saving features while delivering a voice over Internet protocol (VoIP) service may want to re-select an IEEE 802.11n AP that supports the same capabilities. However, with the current state-of-the-art, the STA does not know if the target AP employs these IEEE 802.11n power-saving features. This may result in increased STA power consumption or frequent re-selections of APs until the STA finds a suitable IEEE 802.11n AP.

### SUMMARY

The present invention is related to a method and system for enhanced BSS transition for high-throughput WLAN systems. The WLAN includes at least one high throughput-enabled AP, at least one additional AP, (high throughput-enabled or non-high throughput-enabled AP), and at least one high throughput-enabled STA. A STA and a target AP communicate high throughput-related information, such as IEEE 802.11n capabilities or features, and the STA performs a BSS transition to the target AP based on the communicated high throughput-related information. The high throughput-related information may be communicated directly between the STA and the target AP or via a current AP. The high throughput-related information may be included in an IEEE 802.11r, 802.11k, or 802.11v signaling message, or the like. The STA may generate and send measurement reports for an extended range and a normal range of an AP separately, or may generate and send a combined measurement report for an extended range and a normal range of an AP. A network management entity may obtain current status information of the STA and the AP regarding high throughput capabilities, features and parameters and selectively enable and disable at least one of the high throughput capabilities, features and parameters of the STA and the AP (current or target).

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 shows a wireless communication system operating in accordance with the present invention; and

FIG. 2 is a flow diagram of a process for enhanced BSS transition in accordance with the present invention.

### DETAILED DESCRIPTION OF THE PREFERRED EMBODIMENTS

When referred to hereafter, the terminology “STA” includes but is not limited to a user equipment, a wireless transmit/receive unit (WTRU), a fixed or mobile subscriber unit, a pager, or any other type of device capable of operating in a wireless environment. When referred to hereafter, the terminology “AP” includes but is not limited to a Node-B, a base station, a site controller or any other type of interfacing device in a wireless environment.

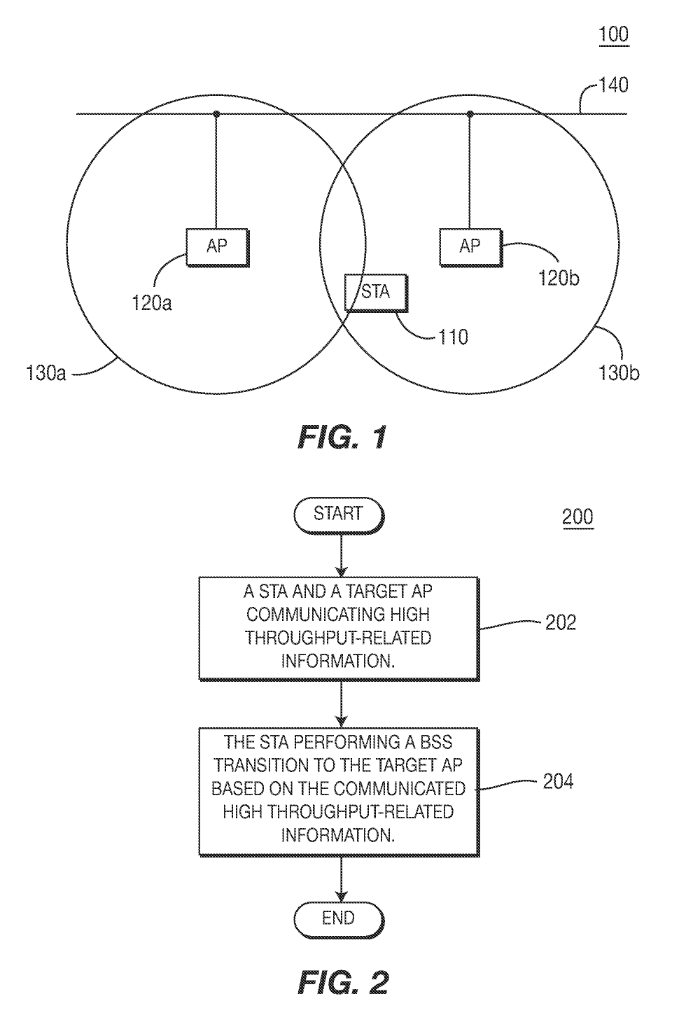

FIG. 1 shows a wireless communication system 100 operating in accordance with the present invention. The system 100 includes a STA 110 and a plurality of APs 120a, 120b. The STA 110 is a high throughput-enabled STA, (such as an IEEE 802.11n-enabled STA), and at least one AP, (e.g., AP 120b), is a high throughput-enabled AP, (such as an IEEE 802.11n-enabled AP). Each AP 120a, 120b serves a BSS 130a, 130b, respectively. The APs 120a, 120b are connected to a DS 140, which may form an extended service set (ESS). The APs 120a, 120b may belong to different ESSs. The STA 110 is currently associated with an AP 120a and needs to perform a BSS transition to an AP 120b, (i.e., a target AP). In accordance with the present invention, high throughput, (e.g., IEEE 802.11n), capabilities, features and parameters may be exchanged, enabled, disabled or modified either at start-up or during system operation.

FIG. 2 is a flow diagram of a process 200 for enhanced BSS transition in accordance with the present invention. The STA 110 and the target AP 120b communicate high throughput-related information, (i.e., high throughput-related capabilities, features, parameters, and the like), before BSS transition (step 202). The STA 110 performs a BSS transition to the target AP 120b based on the communicated high throughput-related information (step 204). The high throughput-related information may be communicated either directly between the STA 110 and the target AP 120b, (i.e., “over-the-air”), or through the AP, (e.g., the AP 120a), with which the STA 110 is currently associated, (i.e., “over-the-DS”). In accordance with the present invention, the STA 110 and the target AP 120b are aware of the high throughput-related information of the STA 110 and the target AP 120b prior to the BSS transition and may avoid the potential problems due to uncertainty with respect to the high throughput capability and features.

The high throughput-related information may be included in an existing signaling message including a signaling message based on IEEE 802.11r, 802.11v and 802.11k standards. For carrying the high throughput-related information, at least one information element (IE) may be added to the existing signaling messages. Alternatively, the currently defined IE may be enhanced or expanded to provide the high throughput-related information. It should be noted that the terminology “IE” is used as a generic description and may be extended to any information-carrying signaling messages or information-carrying data elements in any frame type or element.

The high throughput-related information may be included in a management frame, a control frame, an action frame, a data frame, or any type of frame. The high throughput-related information may be included in a beacon frame, a probe request frame, a probe response frame, a secondary or auxiliary beacon frame, (e.g., a beacon frame used to support an extended range feature), an association request frame, an association response frame, a re-association request frame, a re-association response frame, an authentication request frame, an authentication response frame, or within any frame.

The high throughput-related information may be included in an IEEE 802.11r signaling messages, such as a fast transition (FT) action request frame and an FT action response frame. The high throughput-related information may be included in an IEEE 802.11k signaling messages, such as a measurement pilot frame, an AP channel request element, an AP channel report element, a neighbor report request frame or element, a neighbor report response frame or element. The high throughput-related information may be included in an IEEE 802.11v signaling message, such as a roaming management request frame or element, and a roaming management response frame or element.

The high throughput-related information, (e.g., IEEE 802.11n-related information), that may be communicated between a STA and an AP, among STAs or among APs is listed in Table 1. It should be noted that the list in Table 1 is provided as an example and any other relevant information may be further included. At least one of the information listed in Table 1 may be communicated for a BSS transition for high-throughput STAs.

TABLE 1

| High throughput-related | |
|---|---|
| information | Required Level of Support |
| A frame aggregation format | Mandatory. |
| that allows aggregation of | Recipient shall receive an A-MPDU |
| multiple Medium Access | aggregation that is not greater than the |
| Control (MAC) Protocol | negotiated size. Minimum separation of |
| Data Units (PDUs) | MPDUs in an A-MPDU is negotiable |
| (MPDUs) in one physical | (MPDU density). Frames requiring an ACK |
| layer service data unit | can only be sent as a legacy physical |
| (PSDU), (i.e., aggregated | layer protocol data unit (PPDU) or |
| MPDU (A-MPDU)) | a high throughput (HT) non-aggregate |
| | PPDU. Only single receiver address |
| | aggregation is supported. |
| A frame aggregation format | Mandatory. |
| that allows aggregation of | Recipient shall receive and de-aggregate |
| multiple MAC service data | an A-MSDU. The recipient supports one |
| units (MSDUs) in one | of two maximum lengths at its option. |
| MPDU, (i.e., aggregated | |
| MSDU (A-MSDU)) | |
| Block Acknowledgement | Mandatory when A-MPDU is used. |
| (BA) mechanism | HT stations shall support BA. |
| N-immediate BA | Mandatory |
| N-delayed BA including No | Optional |
| Acknowledgement (ACK) | |
| on BA/block ACK request | |
| (BAR) | |
| Compressed bitmap BA | Mandatory |
| Implicit BA request by | Mandatory at Recipient |
| asserting “Normal ACK” | |
| of an MPDU aggregated | |
| in PSDU | |
| Recipient partial state | Mandatory under N-Immediate BA |
| Security | Open and counter-mode/CBC-MAC protocol |
| | (CCMP) only |
| Long network allocation | Mandatory |
| vector (NAV) reservation | Receiver shall respect this type of protection. |
| with contention free | |
| (CF)-end for NAV release | |
| Physical layer (PHY) level | Mandatory |
| spoofing | The length field of the Non-HT signal field |
| | (L-SIG) field of a mixed mode packet shall |
| | have a value equivalent to the duration of |
| | the current PPDU when L-SIG transmission |
| | opportunity (TXOP) protection is not used. |
| Multiple-input multiple- | Mandatory to honor any MIMO power save |
| output (MIMO) power save | notifications |
| Reduce MIMO capability | Mandatory to honor any reduced MIMO |
| | capability notifications |
| Mechanisms to manage | Mandatory |
| coexistence of 20 and | Both transmitter and receiver shall support |
| 40 MHz channels. | |
| Channel management and | Mandatory |
| channel selection methods. | Both transmitter and receiver shall support. |
| Reduced inter-frame | Mandatory |
| spacing (RIFS) protection | |
| Green field protection | Mandatory |
| Power save multi-poll | Support of PSMP is optional. However, |
| (PSMP) | use of PSMP by an AP is mandatory |
| | for multiple receiver addresses (RAs) |
| | packet transmission with RIFS or short |
| | interframe spacing (SIFS) to support |
| | PSMP capable STA. |
| Multiple traffic identifier | MTBA is the only BA mechanism that |
| (TID) BA (MTBA) | shall be used during a PSMP sequence. |
| Space Time Block Coding | STBC control frames allow stations to |
| (STBC) control frames | associate beyond the non-STBC range. |
| L-SIG TXOP protection | Optional TXOP protection through L-SIG. |
| Phased coexistence | Optional |
| operation (PCO) | PCO is an optional BSS mode with |
| | alternating 20 MHz phase and 40 MHz |
| | phase controlled by a PCO AP. |
| | A PCO capable STA may associate with |
| | the BSS as a PCO STA. |
| Transmit beamforming | Optional |
| Fast link adaptation | Optional MCS request and response |
| Implicit feedback | Optional request and response of |
| | Responder's sounding |
| Channel state information | Optional request and response of CSI |
| (CSI) feedback | |
| Zero length frame (ZLF) | Optional use of ZLF as sounding frame |
| sounding | |
| Calibration | Optional calibration support |
| Reverse direction | Optional support of Responder's data |
| | transfer |
| Antenna selection | Optional support of antenna selection |

In addition to the information in Table 1, at least one of the following information may also be communicated for fast BSS transition services for high-throughput STAs:

1) Availability of IEEE 802.11n services;

2) Availability of BA resources, and the pre-setup of BA agreements;

3) Setup of A-MPDU aggregation parameters, such as an MPDU density parameter;

4) Availability of PSMP service;

5) Availability of automatic power save delivery (APSD) service and parameters;

6) Availability of extended range service; and

7) Availability of certain data rates (i.e., modulation and coding scheme (MCS)), such as space time block coding (STBC)-based MCS.

Extended range feature has been designed to improve the range of the WLAN and remove dead spots. When the extended range feature is implemented, some STAs may utilize extended range MCS, (e.g., space time block coding (STBC)), and the effective range of the AP is extended, while other STAs may utilize normal range and normal MCS. The BSS range may be viewed as comprising two areas, one for extended range and the other for normal range. The extended range area encompasses the normal range area.

For the extended range features, STAs and APs may exchange a neighbor report frame, a measurement pilot frame, a measurement request/response frame (or element), a link measurement request/response frame (or element), or the like. The neighbor report frame is transmitted to report neighboring APs including neighboring AP information. The measurement pilot frame contains information regarding measurements. The measurement request frame (or element) contains a request that the receiving STA undertake the specified measurement action. The link measurement request frame is transmitted by a STA to request another STA to respond with a link measurement report frame to enable measurement of link path loss and estimation of link margin.

In accordance with the present invention, in performing and reporting measurements per neighbor cell, the STAs may generate two separate and independent measurement reports, one for the extended range and the other for the normal range. Alternatively, the STAs may generate a single combined measurement report for both the extended range and the normal range.

The high throughput capabilities, features and parameters may be selectively enabled or disabled by a network management entity. A remote or local network management entity communicates with individual APs, a group of APs, individual STAs or groups of STAs via a layer 2 communication protocol or a layer 3 or higher layer communication protocol to selectively retrieve a current status of employed capabilities, features and parameters of the APs and STAs. The retrieval of the current status information may be performed through a poll, (i.e., request and report mechanism), a periodical reporting, or in an un-solicited manner. After collecting the status information, the network management entity may selectively enable or disenable one or more of the high throughput capabilities, features and parameters stated hereinabove including the list in Table 1.

A simple network management protocol (SNMP) may be used as a signaling protocol. Alternatively, the signaling protocol may use SNMP-like messages. The SNMP messages are encapsulated into L2 frames by an AP for transmission between a STA and the AP, and translated back and forth into SNMP messages in the AP for transmission between the AP and the network management entity. In another alternative, the signaling protocol may be carried inside IP units.

In order to collect the status information of high throughput capabilities, features and parameters, the communication may be via databases implemented on the STA(s), AP(s), the network management entity or a combination of those. Preferably, the database is in the form of a management information base (MIB).

The network management functionality may reside in one or more APs, and APs may exchange information pertaining to high throughput capabilities, features and parameters relevant to APs and/or STAs amongst themselves.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. In a wireless communication system including at least one high throughput-enabled access point (AP) and at least one high throughput-enabled station (STA), a method for enhanced basic service set (BSS) transition from a current AP to a target AP, the method comprising:
said at least one high throughput-enabled STA and a target high throughput-enabled AP communicating high throughput-related information; and
said at least one high throughput enabled STA performing a BSS transition to said target high throughput-enabled AP based on the communicated high throughput-related information.

2. The method of claim 1 wherein the high throughput-related information is communicated directly between said high throughput-enabled STA and said target high throughput-enabled AP.

3. The method of claim 1 wherein the high throughput-related information is communicated via the current AP.

4. The method of claim 1 wherein the high throughput-related information is included in at least one of a beacon frame, a secondary beacon frame, a probe request frame, a probe response frame, an association request frame, an association response frame, a re-association request frame, a re-association response frame, an authentication request frame and an authentication response frame.

5. The method of claim 1 wherein the high throughput-related information is included in at least one of a data frame, a management frame, a control frame and an action frame.

6. The method of claim 1 wherein the high throughput-related information is included in an IEEE 802.11r related signaling message.

7. The method of claim 1 wherein the high throughput-related information is included in an IEEE 802.11k related signaling message.

8. The method of claim 7 wherein the high throughput-related information is included in at least one of a measurement pilot frame, an AP channel request element, an AP channel report element, a neighbor report request frame, a neighbor report response frame, a neighbor report request element, and a neighbor report response element.

9. The method of claim 1 wherein the high throughput-related information is included in an IEEE 802.11v related signaling message.

10. The method of claim 9 wherein the high throughput-related information is included in at least one of a roaming management request frame, a roaming management request element, a roaming management response frame, and a roaming management response element.

11. The method of claim 1 wherein the high throughput-related information is IEEE 802.11n related information.

12. The method of claim 1 wherein the high throughput-related information includes at least one of availability of IEEE 802.11n services, availability of block acknowledgement (ACK) resources and pre-setup of block ACK agreements, setup of aggregated medium access control protocol data unit (A-MPDU) aggregation parameters, availability of power save multi-poll (PSMP) service, availability of automatic power save delivery (APSD) service and parameters, availability of extended range service, and availability of certain data rates.

13. The method of claim 1 wherein the high throughput-related information includes at least one of capabilities, features, and parameters of said high throughput-enabled STA and said target high throughput-enabled AP.

14. The method of claim 1 wherein the high throughput-related information indicates a frame aggregation format that allows aggregation of multiple medium access control (MAC) protocol data units (MPDUs) in one physical service data unit (PSDU).

15. The method of claim 1 wherein the high throughput-related information indicates a frame aggregation format that allows aggregation of multiple medium access control (MAC) service data units (MSDUs) in one MAC protocol data unit (MPDU).

16. The method of claim 1 wherein the high throughput-related information indicates a block acknowledgement mechanism.

17. The method of claim 1 wherein the high throughput-related information indicates an N-Immediate block acknowledgement.

18. The method of claim 1 wherein the high throughput-related information indicates an N-delayed block acknowledgement (BA) including a no acknowledgement on a BA or a BA request (BAR).

19. The method of claim 1 wherein the high throughput-related information indicates compressed bitmap block acknowledgement.

20. The method of claim 1 wherein the high throughput-related information indicates implicit block acknowledgement request by asserting normal acknowledgement of a medium access control (MAC) protocol data unit (MPDU) aggregated in a physical service data unit (PSDU).

21. The method of claim 1 wherein the high throughput-related information indicates long network allocation vector (NAV) reservation with contention free (CF)-end for NAV release.

22. The method of claim 1 wherein the high throughput-related information indicates physical layer level spoofing.

23. The method of claim 1 wherein the high throughput-related information indicates multiple-input multiple-output (MIMO) power save.

24. The method of claim 1 wherein the high throughput-related information indicates reduce multiple-input multiple-output (MIMO) capability.

25. The method of claim 1 wherein the high throughput-related information indicates mechanisms to manage coexistence of 20 and 40 MHz channels.

26. The method of claim 1 wherein the high throughput-related information indicates channel management and channel selection methods.

27. The method of claim 1 wherein the high throughput-related information indicates reduced inter-frame spacing (RIFS) protection.

28. The method of claim 1 wherein the high throughput-related information indicates green field protection.

29. The method of claim 1 wherein the high throughput-related information indicates power save multiple poll (PSMP).

30. The method of claim 1 wherein the high throughput-related information indicates multiple traffic identifier (TID) block acknowledgement.

31. The method of claim 1 wherein the high throughput-related information indicates space time block coding (STBC) control frames.

32. The method of claim 1 wherein the high throughput-related information indicates non-high throughput (HT) signal field (L-SIG) transmit opportunity protection.

33. The method of claim 1 wherein the high throughput-related information indicates a point of control and observation (PCO) capability.

34. The method of claim 1 wherein the high throughput-related information indicates transmit beamforming capability.

35. The method of claim 1 wherein the high throughput-related information indicates fast link adaptation.

36. The method of claim 1 wherein the high throughput-related information indicates implicit feedback.

37. The method of claim 1 wherein the high throughput-related information indicates channel state information (CSI) feedback.

38. The method of claim 1 wherein the high throughput-related information indicates use of a zero length frame as a sounding frame.

39. The method of claim 1 wherein the high throughput-related information indicates calibration support.

40. The method of claim 1 wherein the high throughput-related information indicates reverse direction support of responder's data transfer.

41. The method of claim 1 wherein the high throughput-related information indicates antenna selection.

42. The method of claim 1 wherein said high throughput-enabled STA generates and sends measurement reports for an extended range and a normal range of said high throughput-enabled AP independently.

43. The method of claim 1 wherein said high throughput-enabled STA generates and sends a combined measurement report for an extended range and a normal range of said high throughput-enabled AP.

44. The method of claim 1 further comprising:
a network management entity obtaining current status information of said high throughput-enabled STA and said high throughput-enabled AP regarding high throughput capabilities, features and parameters; and
the network management entity selectively enabling and disabling at least one of the high throughput capabilities, features and parameters of said high throughput-enabled STA and said high throughput-enabled AP.

45. The method of claim 44 wherein the network management entity is included in said high throughput-enabled AP.

46. The method of claim 44 wherein the network management entity, said high throughput-enabled STA and said high throughput-enabled AP communicate via a layer 2 communication protocol retrieve the current status information.

47. The method of claim 44 wherein the network management entity, said high throughput-enabled STA and said high throughput-enabled AP communicate via a layer 3 communication protocol retrieve the current status information.

48. The method of claim 44 wherein the current status information is retrieved through a poll.

49. The method of claim 44 wherein the current status information is retrieved through a periodical reporting.

50. The method of claim 44 wherein the current status information is retrieved in an un-solicited manner.

51. The method of claim 44 wherein the network management entity, said high throughput-enabled STA and said high throughput-enabled AP communicate using a simple network management protocol (SNMP).

52. The method of claim 44 wherein the network management entity, said high throughput-enabled STA and said high throughput-enabled AP communicate using simple network management protocol (SNMP)-like messages, wherein SNMP messages are encapsulated into L2 frames by said high throughput-enabled AP for transmission between said high throughput-enabled STA and said high throughput-enabled AP and translated back and forth into SNMP messages in said high throughput-enabled AP for transmission between said high throughput-enabled AP and the network management entity.

53. The method of claim 44 wherein the network management entity, said high throughput-enabled STA and said high throughput-enabled AP communicate using Internet protocol (IP) units.

54. The method of claim 44 wherein the status information is collected via databases implemented on at least one of said high throughput-enabled STA, said high throughput-enabled AP and the network management entity.

55. The method of claim 54 wherein the database is in a form of a management information base (MIB).

56. The method of claim 1 wherein the current AP and said target high throughput-enabled AP belong to the same extended service set (ESS).

57. The method of claim 1 wherein the current AP and said target high throughput-enabled AP belong to different extended service sets (ESSs).

58. A wireless communication system for enhanced basic service set (BSS) transition from a current access point (AP) to a target AP, the system comprising:
at least one high throughput-enabled AP configured to communicate high throughput-related information; and
at least one high throughput-enabled station (STA) configured to communicate high throughput-related information and perform a BSS transition to the target AP based on the communicated high throughput-related information.

59. The system of claim 58 wherein the high throughput-related information is communicated directly between the STA and the target AP.

60. The system of claim 58 wherein the high throughput-related information is communicated between the STA and the target AP via the current AP.

61. The system of claim 58 wherein the high throughput-related information is included in at least one of a beacon frame, a secondary beacon frame, a probe request frame, a probe response frame, an association request frame, an association response frame, a re-association request frame, a re-association response frame, an authentication request frame and an authentication response frame.

62. The system of claim 58 wherein the high throughput-related information is included in at least one of a data frame, a management frame, a control frame and an action frame.

63. The system of claim 58 wherein the high throughput-related information is included in an IEEE 802.11r related signaling message.

64. The system of claim 58 wherein the high throughput-related information is included in an IEEE 802.11k related signaling message.

65. The system of claim 64 wherein the high throughput-related information is included in at least one of a measurement pilot frame, an AP channel request element, an AP channel report element, a neighbor report request frame, a neighbor report response frame, a neighbor report request element, and a neighbor report response element.

66. The system of claim 58 wherein the high throughput-related information is included in an IEEE 802.11v related signaling message.

67. The system of claim 66 wherein the high throughput-related information is included in at least one of a roaming management request frame, a roaming management request element, a roaming management response frame, and a roaming management response element.

68. The system of claim 58 wherein the high throughput-related information is IEEE 802.11n related information.

69. The system of claim 58 wherein the high throughput-related information includes at least one of availability of IEEE 802.11n services, availability of block acknowledgement (ACK) resources and pre-setup of block ACK agreements, setup of aggregated medium access control protocol data unit (A-MPDU) aggregation parameters, availability of power save multi-poll (PSMP) service, availability of automatic power save delivery (APSD) service and parameters, availability of extended range service, and availability of certain data rates.

70. The system of claim 58 wherein the high throughput-related information includes at least one of capabilities, features, and parameters of the AP and the STA.

71. The system of claim 58 wherein the high throughput-related information indicates a frame aggregation format that allows aggregation of multiple medium access control (MAC) protocol data units (MPDUs) in one physical service data unit (PSDU).

72. The system of claim 58 wherein the high throughput-related information indicates a frame aggregation format that allows aggregation of multiple medium access control (MAC) service data units (MSDUs) in one MAC protocol data unit (MPDU).

73. The system of claim 58 wherein the high throughput-related information indicates a block acknowledgement mechanism.

74. The system of claim 58 wherein the high throughput-related information indicates an N-immediate block acknowledgement.

75. The system of claim 58 wherein the high throughput-related information indicates an N-delayed block acknowledgement (BA) including a no acknowledgement on a BA or a BA request (BAR).

76. The system of claim 58 wherein the high throughput-related information indicates compressed bitmap block acknowledgement.

77. The system of claim 58 wherein the high throughput-related information indicates implicit block acknowledgement request by asserting normal acknowledgement of a medium access control (MAC) protocol data unit (MPDU) aggregated in a physical service data unit (PSDU).

78. The system of claim 58 wherein the high throughput-related information indicates long network allocation vector (NAV) reservation with contention free (CF)-end for NAV release.

79. The system of claim 58 wherein the high throughput-related information indicates physical layer level spoofing.

80. The system of claim 58 wherein the high throughput-related information indicates multiple-input multiple-output (MIMO) power save.

81. The system of claim 58 wherein the high throughput-related information indicates reduce multiple-input multiple-output (MIMO) capability.

82. The system of claim 58 wherein the high throughput-related information indicates mechanisms to manage coexistence of 20 and 40 MHz channels.

83. The system of claim 58 wherein the high throughput-related information indicates channel management and channel selection methods.

84. The system of claim 58 wherein the high throughput-related information indicates reduced inter-frame spacing (RIFS) protection.

85. The system of claim 58 wherein the high throughput-related information indicates green field protection.

86. The system of claim 58 wherein the high throughput-related information indicates power save multiple poll (PSMP).

87. The system of claim 58 wherein the high throughput-related information indicates multiple traffic identifier (TID) block acknowledgement.

88. The system of claim 58 wherein the high throughput-related information indicates space time block coding (STBC) control frames.

89. The system of claim 58 wherein the high throughput-related information indicates non-high throughput (HT) signal field (L-SIG) transmit opportunity protection.

90. The system of claim 58 wherein the high throughput-related information indicates a point of control and observation (PCO) capability.

91. The system of claim 58 wherein the high throughput-related information indicates transmit beamforming capability.

92. The system of claim 58 wherein the high throughput-related information indicates fast link adaptation.

93. The system of claim 58 wherein the high throughput-related information indicates implicit feedback.

94. The system of claim 58 wherein the high throughput-related information indicates channel state information (CSI) feedback.

95. The system of claim 58 wherein the high throughput-related information indicates use of a zero length frame as a sounding frame.

96. The system of claim 58 wherein the high throughput-related information indicates calibration support.

97. The system of claim 58 wherein the high throughput-related information indicates reverse direction support of responder's data transfer.

98. The system of claim 58 wherein the high throughput-related information indicates antenna selection.

99. The system of claim 58 wherein the STA generates and sends measurement reports for an extended range and a normal range of an AP independently.

100. The system of claim 58 wherein the STA generates and sends a combined measurement report for an extended range and a normal range of an AP.

101. The system of claim 58 further comprising:
a network management entity configured to obtain current status information of the STA and the AP regarding high throughput capabilities, features and parameters and selectively enable and disable at least one of the high throughput capabilities, features and parameters of the STA and the AP.

102. The system of claim 101 wherein the network management entity is included in the AP.

103. The system of claim 101 wherein the network management entity, the STA and the AP communicate via a layer 2 communication protocol retrieve the current status information.

104. The system of claim 101 wherein the network management entity, the STA and the AP communicate via a layer 3 communication protocol retrieve the current status information.

105. The system of claim 101 wherein the current status information is retrieved through a poll.

106. The system of claim 101 wherein the current status information is retrieved through a periodical reporting.

107. The system of claim 101 wherein the current status information is retrieved in an un-solicited manner.

108. The system of claim 101 wherein the network management entity, the STA and the AP communicate using a simple network management protocol (SNMP).

109. The system of claim 101 wherein the network management entity, the STA and the AP communicate using simple network management protocol (SNMP)-like messages, wherein SNMP messages are encapsulated into L2 frames by the AP for transmission between the STA and the AP and translated back and forth into SNMP messages in the AP for transmission between the AP and the network management entity.

110. The system of claim 101 wherein the network management entity, the STA and the AP communicate using Internet protocol (IP) units.

111. The system of claim 101 wherein the status information is collected via databases implemented on at least one of the STA, the AP and the network management entity.

112. The system of claim 111 wherein the database is in a form of a management information base (MIB).

113. The system of claim 58 wherein the current AP and the target AP belong to the same extended service set (ESS).

114. The system of claim 58 wherein the current AP and the target AP belong to different extended service sets (ESSs).
